(19) United States
(12) Patent Application Publication
(10) Pub. No.: US 2007/0253765 A1
(43) Pub. Date: Nov. 1, 2007

(54) Ball joint

(75) Inventors: Axel Knopp, Eitelborn (DE); Horst Maury, St. Sebastian (DE); Arnold Schilz, Lahnstein (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/796,658

(22) Filed: Apr. 27, 2007

(30) Foreign Application Priority Data
Apr. 29, 2006 (DE) 10 2006 020 103.5

(51) Int. Cl. F16C 11/00

(52) U.S. Cl. 403/122

(57) ABSTRACT

A ball joint includes a ball head with a radially extending neck, and a socket housing having a ball socket and a fastening shaft which extends radially with respect to the ball socket. The socket has an insertion opening facing transversely of the fastening shaft, the opening having a periphery provided with a pivot notch opposite the fastening shaft, wherein the pivot notch has a width which is smaller than the diameter of the insertion opening and greater than the diameter of the pivot neck. A securing element engages the ball head and loads it into the socket, the securing element being removable away from the insertion opening to release the ball head from the socket. The neck can pivot into the notch while the ball is engaged by the securing element.

### BACKGROUND OF THE INVENTION

1. Field of the Invention

The invention relates to a ball joint, in particular for articulating gas springs on associated unit parts, having a ball head which is mounted pivotably in a ball socket which is of closed hemispherical configuration in a socket housing, the socket housing having a fastening shaft which extends radially with respect to the ball socket and the ball socket leading to the outside via an insertion opening which extends transversely with respect to the fastening shaft, having a ball neck which is arranged on the ball head in a radially extending manner, and having a securing element, by way of which the ball head can be engaged around and can be prestressed into the ball socket, and which securing element can be moved out of the region of the insertion opening in a manner which releases the ball head.

2. Description of the Related Art

Ball joints of this type are used, in particular, for articulating gas springs in motor vehicles, the ball joints serving for the moving drive of pivotable parts such as flaps.

Here, it is known that the ball neck extends at right angles to the fastening shaft of the socket housing and is mounted thereon in the ball socket in a manner such that it deviates by only a few degrees and can be pivoted via its ball head.

This makes mounting on fastening locations of the ball neck which are difficult to reach possible only with difficulty or even not at all.

### SUMMARY OF THE INVENTION

It is therefore an object of the invention to provide a ball joint which makes easy mounting of the ball pivot possible with a simple construction at fastening locations which are difficult to access.

According to the invention, a pivot notch is formed in the socket housing, which pivot notch has a width which is smaller than the diameter of the insertion opening and is equal to or greater than the diameter of the ball neck. The pivot notch connects the insertion opening to the outside, at least approximately over its entire length, counter to the extent direction of the fastening shaft.

This makes it possible for the ball neck of the ball joint which has already been finally assembled to be moved for mounting into a position which is oriented at least approximately in accordance with the longitudinal extent of the fastening shaft. In this position the ball neck can be fed to the fastening location on a unit part, such as a body part of a motor vehicle, and can be connected to the latter.

For this purpose, the ball neck can be provided in a simple manner with a thread and can be screwed approximately perpendicularly into a hole in a sheet metal part, for example, of the vehicle body or the flap or into a threaded hole. Fastening locations at positions which are difficult to access are therefore also possible.

Fastening via a bent piece of sheet metal is not required.

The insertion opening can adjoin the ball socket cylindrically and have a diameter which corresponds to the diameter of the ball head.

For simple securing of the ball head in the ball socket, it is possible, with the ability to be mounted simply, that the securing element is a C-shaped spring clamp which engages around the socket housing transversely with respect to the longitudinal extent of the fastening shaft on the side which faces away from the insertion opening, protrudes through leadthrough slots in the socket housing by way of its free ends, and loads the ball head on its side which is opposite the ball socket.

Here, the spring clamp is preferably a spring strip of rectangular cross section, and the leadthrough slots have a cross section which corresponds to the cross section of the spring strip.

In order to make the spring clamp simple to mount, the socket housing is formed with outwardly open feed slots which extend in the longitudinal extent direction of the fastening shaft from the end side which is opposite the fastening shaft, which feed slots open into the leadthrough slots.

The spring clamp is secured in its installation position in a simple manner by the fact that the socket housing has locking cams which project on its outer face which faces away from the insertion opening, it being possible for the spring clamp to be arranged between the locking cams.

In a further configuration of the securing means of the ball head in the ball socket with a simple construction and an ability to be mounted simply, a spring tongue extends in the region of the wall of the insertion opening in accordance with the extent of the insertion opening. This spring tongue is connected by way of its proximal end to the socket housing in the region of the equator of the ball socket and has a projection which protrudes into the region of the insertion opening on its distal end. A slot being formed in the socket housing parallel to the spring tongue on the side which faces away from the insertion opening, into which slot the spring tongue can be pivoted, and into which slot a displacer element can be inserted.

Manufacturing is simple here if the slot is of continuous configuration in the socket housing.

Firm seating of the displacer element in the slot is achieved by the fact that the displacer element has a cross section which corresponds to the cross section of the slot.

In order to secure the displacer element against automatic release from its locking position, the displacer element can be locked in its locking position which is inserted completely into the slot.

If the displacer element can be locked in its partial insertion position which releases the pivotability of the spring tongue, it is also secured against being lost in this position.

The displacer element can preferably be locked with a form-fitting connection.

This is effected in a simple manner by the fact that the displacer element has a latching detent which projects transversely with respect to the extent direction of the slot and can be latched resiliently into a latching recess which is formed in the wall of the slot in the locking position and/or in the partial insertion position.

Here, that region of the slot which has the latching recess and faces away from the insertion opening can be deformed elastically in a manner which expands the cross section of the slot.

This can be achieved in a simple manner by configuring that that region of the wall of the slot which has the latching recess for the locking position as a freely projecting spring arm, the fixed end of which is situated approximately in the region of the equator of the ball socket. It is possible for the displacer element to have a latching detent which can be latched both into a locking latching recess which defines the locking position and also into a release latching recess which defines the partial insertion position.

Simple components which can be manufactured easily result from the fact that the socket housing and/or the ball head and/or the displacer element are/is plastic parts, it being possible for the latching detent to be a part which is formed integrally on the displacer element.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a perspective view of a first exemplary embodiment of a ball joint having a pivotability of the ball neck of 60°, with a ball neck which is oriented at right angles to the longitudinal extent of a fastening shaft;

FIG. 2 shows a cross section through the ball joint according to FIG. 1;

FIG. 3 shows a cross section through the ball joint according to FIG. 1, with a ball neck which is pivoted to the maximum extent from its right-angled position;

FIG. 4 shows a perspective view of a second exemplary embodiment of a ball joint having a pivotability of the ball neck 90°, with a ball neck which is oriented at right angles to the longitudinal extent of a fastening shaft;

FIG. 5 shows a cross section through the ball joint according to FIG. 4;

FIG. 6 shows a cross section through the ball joint according to FIG. 4, with a ball neck which is pivoted to the maximum extent from its right-angled position;

FIG. 7 shows a view of a socket housing of the ball joint according to FIG. 4, towards the opening side of the insertion opening;

FIG. 8 shows an opening-side view of the spring clip of the ball joint according to FIG. 4;

FIG. 9 shows a side view of the spring clip according to FIG. 8;

FIG. 10 shows a perspective view of a third exemplary embodiment of a ball joint having a pivotability of the ball neck of 90°, with a ball neck which is oriented at right angles to the longitudinal extent of a fastening shaft;

FIG. 11 shows a cross section through the ball joint according to FIG. 10, with a displacer element in the partial insertion position;

FIG. 12 shows a cross section through the ball joint according to FIG. 10, with a ball neck which is pivoted to the maximum extent from its right-angled position;

FIG. 13 shows a perspective cross-sectional view of the socket housing of the ball joint according to FIG. 10, with the displacer element in the partial insertion position;

FIG. 14 shows a perspective cross-sectional view of the socket housing of the ball joint according to FIG. 10, with the displacer element in the locking position; and

FIG. 15 shows a perspective view of the socket housing of the ball joint according to FIG. 10, with the displacer element in the locking position.

### DETAILED DESCRIPTION OF THE PRESENTLY PREFERRED EMBODIMENTS

The ball joints which are shown in the figures have a socket housing 1 with a fastening shaft 2, in which a threaded hole 3 is formed axially for fastening to a gas spring.

Furthermore, a closed hemispherical ball socket 4 is formed in the socket housing 1 transversely with respect to the longitudinal extent of the fastening shaft 2, an insertion opening 5, 5′ leading from the opening of the ball socket 4 to the outside transversely with respect to the longitudinal extent of the fastening shaft 2.

A ball head 6 of identical diameter is inserted pivotably into the ball socket 4 via the insertion opening 5, 5′, which ball head 6 has a radially extending ball neck 7 for fastening to a component, such as a body part of a motor vehicle.

Furthermore, the pivot notch 8 is formed in the socket housing 1, which pivot notch 8 connects the insertion opening 5, 5′ to the outside, counter to the extent direction of the fastening shaft 2.

The width of the pivot notch 8 is smaller than the diameter of the ball head 6 and corresponds approximately to the diameter of the ball neck 7. It is possible as a result that the ball neck 7 can be pivoted from a position which protrudes through the insertion opening 5, 5′ into a position which is oriented at least approximately counter to the longitudinal extent direction of the fastening shaft 2.

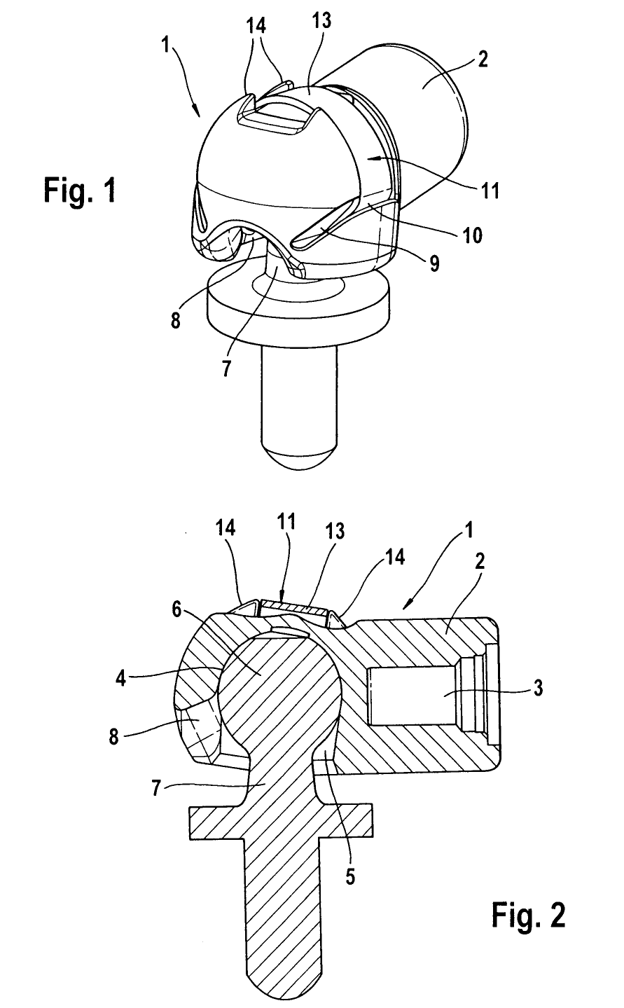

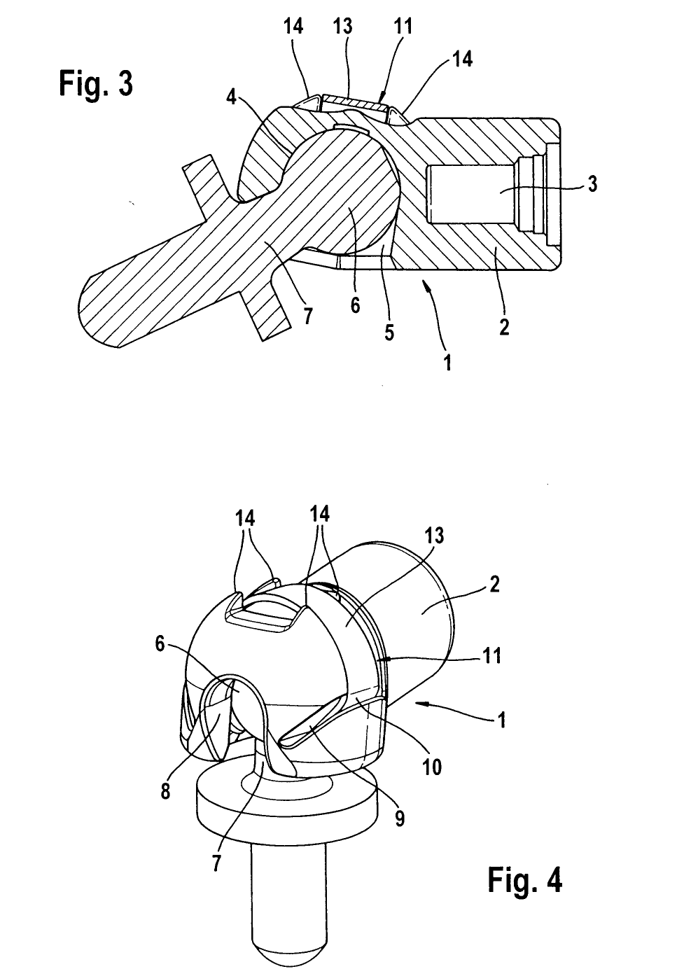

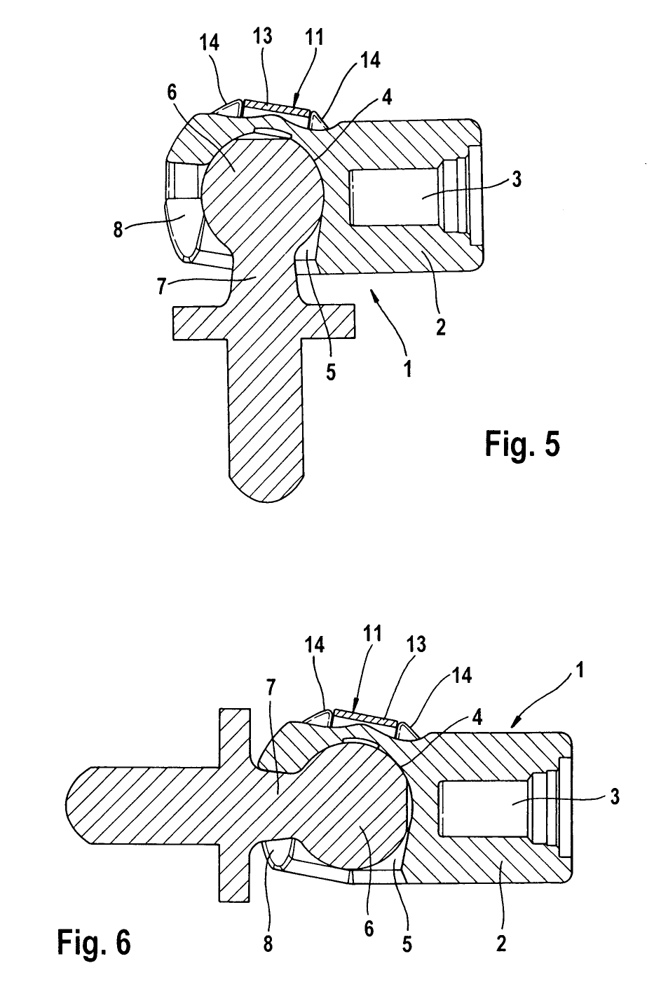

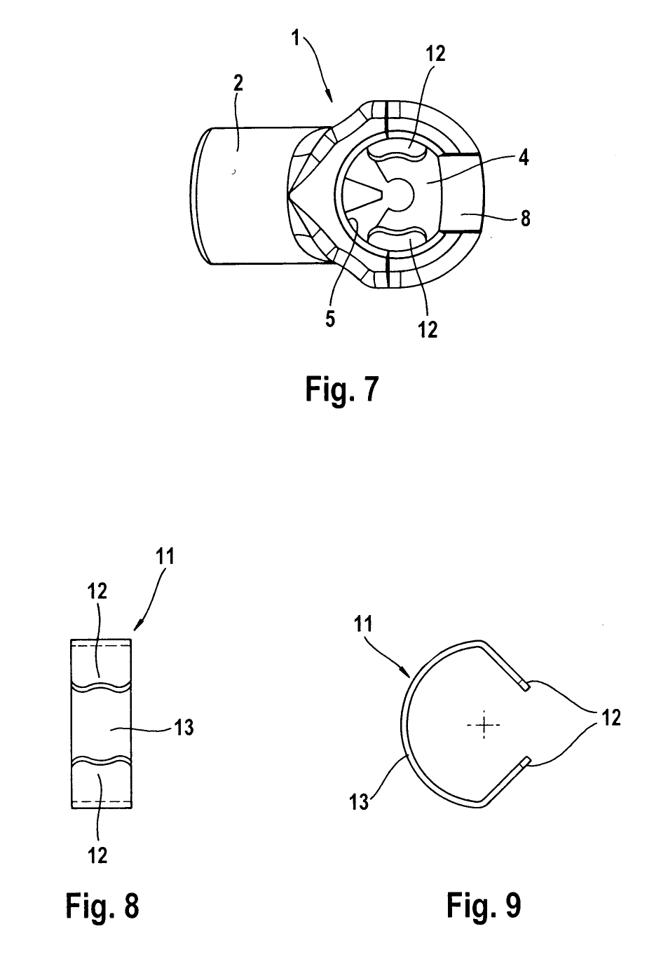

In the exemplary embodiments of FIGS. 1 to 9, the insertion opening 5 is of cylindrical configuration and has a diameter which corresponds to the diameter of the ball head 6.

Two feed slots 9 which open at their ends at the central height of the ball socket 4 into leadthrough slots 10 extend symmetrically with respect to the pivot notch 8 from the end side which is opposite the fastening shaft 2. The leadthrough slots 10 are of converging configuration symmetrically with respect to one another and open approximately into the transition region between the ball socket 4 and the insertion opening 5.

A C-shaped spring clip 11 which consists of a spring strip of rectangular cross section has converging free ends 12 in a manner which corresponds to the converging leadthrough slots 10, the cross section of the spring strip corresponding to the cross section of the leadthrough slots 10 and the thickness of the spring strip corresponding to the width of the feed slots 9.

In order to mount the spring clip 11, the latter is inserted with its free ends 12 from the end side of the socket housing 1 through the feed slots 9 as far as the leadthrough slots 10, in order then to be pushed inwards through the leadthrough slots 10 until the spring clip 11 bears against the socket housing 1 in a manner which engages around the latter with its arcuate part 13 which connects the free ends 12.

The free ends 12 are of such a length that they then protrude into the insertion opening 5 and bear against the ball head 6 in a manner which loads the latter into the ball socket 4.

In this installation position of the spring clip 11, the arcuate part 13 of the spring clip 11 is situated between locking cams 14 which project at the outer face of the socket housing 1 which faces away from the insertion opening 5 and prevent automatic displacement of the spring clip 11.

In the exemplary embodiment of FIGS. 1 to 3, the extent of the pivot slot 8 is such that the ball pivot 7 can be pivoted by 65° from its coaxial position in the insertion opening 5 into the pivot slot 8, while, in the exemplary embodiment of FIGS. 4 to 7, the pivot slot 8 extends to such an extent that even pivoting of 90° is possible.

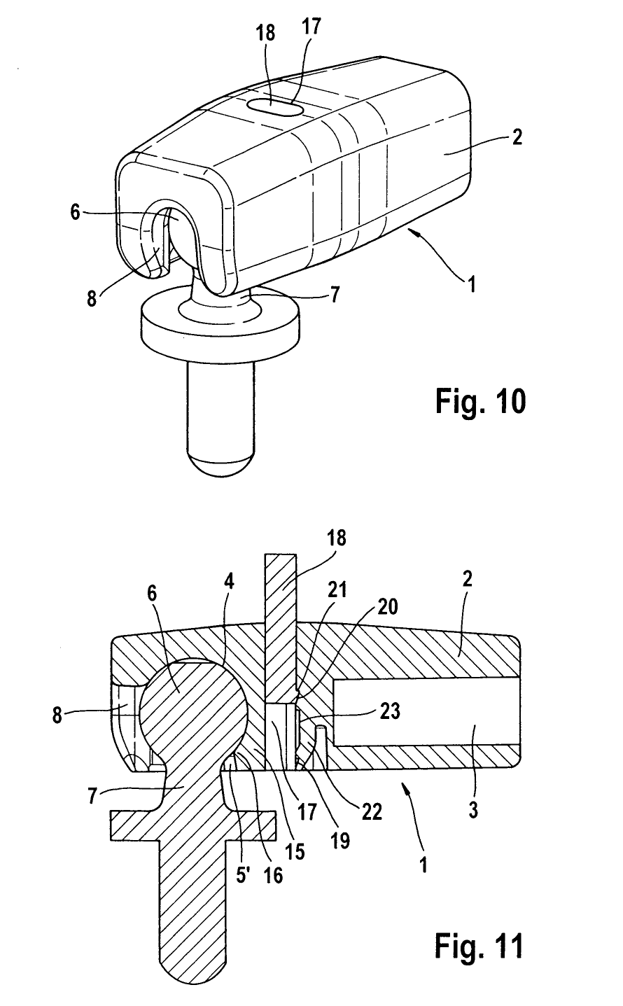

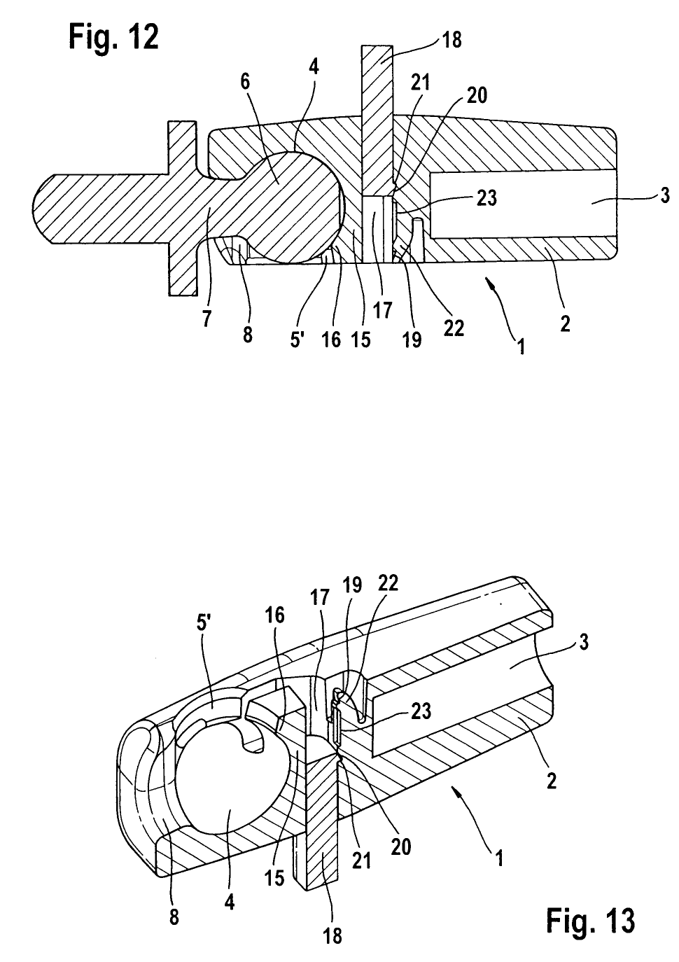

In the exemplary embodiment of FIGS. 10 to 15, the pivot notch 8 corresponds to the pivot notch 8 in FIGS. 4 to 7.

The insertion opening 5′ is also of cylindrical configuration, except for the region of a spring tongue 15.

The spring tongue 15 extends in the region of the wall of the insertion opening 5′ in accordance with the extent of the latter and is connected fixedly to the socket housing 1 by way of its proximal end in the region of the equator of the ball socket 4. At its distal end, the spring tongue 15 has a projection 16 which protrudes radially into the insertion opening 5′ and by which the ball head 6 can be loaded into the ball socket 4.

On that side of the spring tongue 15 which faces away from the insertion opening 5′, a slot 17 is formed continuously in the socket housing 1 parallel to the spring tongue 15, into which slot 17 the spring tongue 15 can be pivoted in such a way that the projection 16 is situated outside the insertion opening 5′.

As a result, the ball head can be guided through the insertion opening 5′ for mounting and dismantling.

In order to secure the installed ball head 6 in the ball socket 4 by the projection 16, a slide-like displacer element 18 can be inserted into the slot 17, which displacer element 18 prevents pivoting of the spring tongue 15 into the slot 17.

In that wall of the slot 17 which faces away from the spring tongue 15, a locking latching recess 19 is formed in one end region of the slot 17 and a release latching recess 20 is formed in the central region of the slot 17.

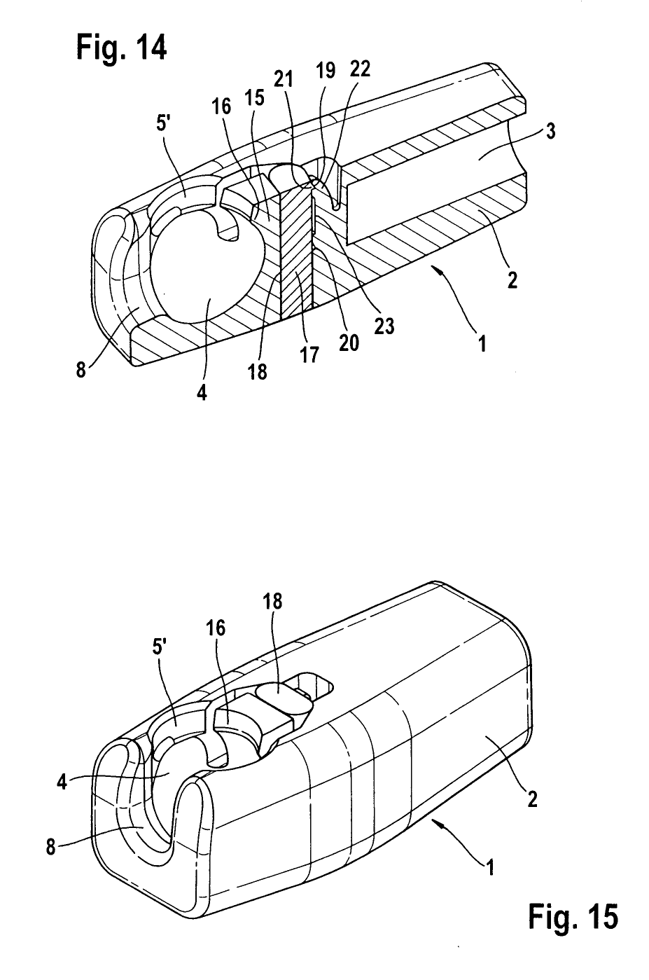

A barb-like elastically deformable latching detent 21 is arranged on the displacer element 18, which latching detent 21 is latched resiliently into the locking latching recess 19 in the locking position which is inserted completely into the slot 17 (FIGS. 14 and 15) and is latched resiliently into the release latching recess 20 in the partial insertion position with a displacer element 18 which is pushed half-way out of the slot 17 (FIGS. 10 to 13).

The spring tongue 15 can be pivoted into the slot 17 in the partial insertion position.

In order for it to be possible to move the latching detent 21 out of the locking latching recess 19, that region of the wall of the slot 17 which has the locking latching recess 19 and faces away from the insertion opening 5′ is configured as a freely protruding spring arm 22, the fixed end of which is situated approximately in the region of the equator of the ball socket 4.

The latching detent 21 is released by pivoting of the spring arm 22, with the result that the displacer element 18 can be moved from the locking position into the partial insertion position.

Here, a groove 23 is formed in the wall of the slot 17 for improved displaceability of the displacer element 18 between the locking latching recess 19 and the release latching recess 20, in which groove 23 the latching detent 21 can move freely.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A ball joint comprising:
a ball head having a diameter;
ball neck extending radially from the ball head and having a diameter;
a socket housing having a ball socket and a fastening shaft which extends radially with respect to the ball socket, the socket having an insertion opening with a diameter, the opening facing transversely of said fastening shaft and having a periphery provided with a pivot notch opposite the fastening shaft, the pivot notch having a width which is smaller than the diameter of the insertion opening and greater than the diameter of the pivot neck; and
a securing element engaging the ball head and loading the ball head into the socket, the securing element being removable away from the insertion opening to release the ball head from the socket.

2. The ball joint of claim 1 wherein the insertion opening is substantially cylindrical and has a diameter which corresponds to the diameter of the ball head.

3. The ball joint of claim 1 wherein the housing has a pair of leadthrough slots between said notch and said fastening shaft, and wherein the securing element is a C-shaped spring clip having free ends connected by an arcuate part, the arcuate part engaging the housing oppositely from the insertion opening, the free ends being received through the slots and engaging the ball head and loading the ball head into the socket.

4. The ball joint of claim 3 wherein the spring clip has a rectangular cross section, the leadthrough slots each having a rectangular cross section which corresponds to the rectangular cross section of the spring clip.

5. The ball joint of claim 3 wherein the housing is provided with a pair of feed grooves communicating with respective said feedthrough slots and extending away from said fastening shaft, said feed grooves being arranged to guide said free ends of said C-shaped spring clip toward said feedthrough slots.

6. The ball joint of claim 3 wherein the socket housing has a pair of locking cams on an outer face facing away from the insertion opening, said arcuate portion of said spring clip being received between said locking cams.

7. The ball joint of claim 1 wherein said housing has a slot between said socket and said fastening shaft, and a spring tongue between said slot and said socket, said spring tongue having a distal end with a projection at said insertion opening, said spring tongue being pivotable into said slot, the ball joint further comprising a displacer element which can be inserted in said slot to prevent the spring tongue from pivoting into the slot.

8. The ball joint of claim 7 wherein the slot extends through the housing.

9. The ball joint of claim 7 wherein the displacer element can be locked in a fully inserted position where the spring tongue cannot be pivoted.

10. The ball joint of claim 9 wherein the slot has a wall formed with a first recess, the displacer element having a latching detent which can engage the first recess to lock the displacer element in the fully inserted position.

11. The ball joint of claim 10 wherein the wall of the slot is formed as a spring arm having a distal end formed with said first recess.

12. The ball joint of claim 10 wherein the wall is formed with a second recess, wherein the latching detent can engage the second recess to lock the displacer element in a partially inserted position.

13. The ball joint of claim 7 wherein the displacer element can be locked in a partially inserted position where the spring tongue can be pivoted.

14. The ball joint of claim 13 wherein the slot has a wall formed with a second recess, the displacer element having a latching detent which can engage the second recess to lock the displacer element in the partially inserted position

15. The ball joint of claim 1 wherein the ball neck can be pivoted into a position which is axially aligned with said fastening shaft while said securing element engages the ball head and loads the ball head into the socket.
